(19) United States
(12) Patent Application Publication
(10) Pub. No.: US 2012/0022900 A1
(43) Pub. Date: Jan. 26, 2012

(54) RETAIL ESTABLISHMENT EXCESS CAPACITY MANAGEMENT AND PRESENTATION SYSTEM AND METHOD

(75) Inventor: RAKESH P. THAKKAR, Chicago, IL (US)

(73) Assignee: FineDineDeal, LLC, Chicago, IL (US)

(21) Appl. No.: 12/832,169

(22) Filed: Jul. 23, 2010

(51) Int. Cl. G06Q 10/00; G06Q 30/00

(52) U.S. Cl. 705/5

(57) ABSTRACT

A method and system of retail establishment excess capacity management and presentation are disclosed. In one embodiment, a computer implemented method includes creating a search result based on criteria of a patron user using a processor. The search result includes an excess capacity across any number of establishments matching the criteria. The method also includes identifying an establishment when a selection of the patron user is processed responsive to the search result. Further, the method includes confirming a reservation of the patron user at the establishment with a payment authority and the establishment, and adjusting the excess capacity based on the reservation.

### FIELD OF TECHNOLOGY

This disclosure relates generally to the field of database technology, and in particular, to a method and system of retail establishment excess capacity management and presentation.

### BACKGROUND

A retail establishment (e.g., a restaurant, a spa, a health club, etc.) may have excess capacity. For example, the excess capacity may be in the form of empty dining tables, unsold perishable items such as food, unused space, and/or overstaffed employee shifts. To reduce the excess capacity, the retail establishment may advertise specials/sales through media channels (e.g., on websites such as Yelp® and OpenTable®, through the newspaper, etc.). However, a consumer response to such specials/sales may be unpredictable.

For example, the consumer response to the specials/sales may unpredictably exceed the excess capacity of the retail establishment. Conversely, the consumer response to the specials/sales may be negligible. It may not be possible for the retail establishment to update the specials/sales through the media channels before a time window in which the excess capacity is marketable expires (e.g., time of day, etc.). As a result, the retail establishment may incur significant financial losses related to the excess capacity (e.g., spoilage, salaries, facility rents, etc.).

### SUMMARY

A method and system of retail establishment excess capacity management and presentation are disclosed. In one aspect, a computer implemented method includes creating a search result based on criteria of a patron user using a processor. The search result includes an excess capacity across any number of establishments matching the criteria. The method also includes identifying an establishment when a selection of the patron user is processed responsive to the search result. Further, the method includes confirming a reservation of the patron user at the establishment with a payment authority and the establishment, and adjusting the excess capacity based on the reservation.

In another aspect, a system includes an excess capacity server having a processor to determine that a region of an establishment is an excess capacity, to present the region to a provider user, and to assign to the excess capacity, a pricing table of the provider user. The pricing table is a function of a time of day variable, a meal plan variable, and a location in the region of the establishment. The system also includes a network, and a client device communicatively coupled with the excess capacity server through the network to create a search result based on a criterion of a patron user. The search result includes the excess capacity across any number of establishments matching the criteria, to identify the establishment when a selection of the patron user is processed responsive to the search result, to confirm a reservation of the patron user at establishment with a payment authority and the establishment, and to adjust the excess capacity based on the reservation.

In yet another aspect, an excess capacity server includes an inventory module, an analysis module, a reservation module, and a promotion module. The inventory module associates an input of a provider user with a time of day variable, a meal plan variable, and a location in a region of an establishment, a price variable, a sale variable, and an auction status selection using a processor. The analysis module aggregates input from two or more provider users, and compiles an availability of an excess capacity of the establishment based on the aggregate input. Further, the analysis module recalculates the excess capacity after a reservation is made by a patron user, provides information to the provider user regarding the reservation of the patron user. The analysis module also blocks other reservations for the excess capacity that has been reserved. In addition the analysis module makes the excess capacity available once a patron user cancels the reservation, and notifies the provider user regarding cancellation.

The reservation module identifies a status of the patron user. The reservation module also selects the excess capacity of the establishment based on the time of day variable, the meal plan variable, and the location in the region of the establishment, the price variable, the sale variable, and the auction status selection, and verifies the selection. The reservation module also verifies the availability of the excess capacity of the establishment, authenticates a financial payment provided by the patron user, accepts the financial payment for the reservation, updates a confirmation of the reservation, and provides notification of the confirmation to the patron user and the provider user.

The promotion module offers a special sale, a group discount, and a seasonal discount provided by the provider user, and notifies the patron user of the special sale, the group discount and the seasonal discount.

Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic view illustrating excess capacity management of an establishment, according to one embodiment.

FIG. 2 is a system view that illustrates communication between a patron user, a provider user and an exec capacity server through a network, according to one embodiment.

FIG. 3 is an exploded view of an excess capacity server, according to one embodiment.

FIG. 4 is diagrammatic view illustrating generation of an inventory module by a provider user, according to one embodiment.

FIG. 5 illustrates reservation of an excess capacity of an establishment by a patron user, according to one embodiment.

FIG. 6 is a flow diagram illustrating promotion module, according to one embodiment.

FIG. 7 is diagrammatic view illustrating analysis of a patron user request against availability of provider user, according to one embodiment.

FIG. 8 is a flow chart illustrating excess capacity management of an establishment, according to one embodiment.

FIG. 9 is a user interface view illustrating inventory of a restaurant having excess capacity, according to one embodiment.

FIG. 10 is a graphical user interface view illustrating a patron user's reservation, according to one embodiment.

FIG. 11A is a user interface view illustrating the available tables at a particular time in a restaurant, according to one embodiment.

FIG. 11B is a user interface view illustrating the layout of table arrangement in a restaurant, according to one embodiment.

FIG. 12 is a graphical user interface illustrating a search view, according to one embodiment.

FIG. 13 is a graphical user interface view illustrating a search result, according to one embodiment.

FIG. 14 is a graphical user interface view illustrating an establishment page, according to one embodiment.

FIG. 15 is graphical user interface view illustrating a configuration view, according to one embodiment.

FIG. 16 is a graphical user interface view illustrating configuration of available tables, according toe embodiment.

Other features of the present embodiments will be apparent from the accompanying drawings and from the detailed description that follows.

### DETAILED DESCRIPTION

A method and system of retail establishment excess capacity management and presentation are disclosed. Although the present embodiments have been described with reference to specific example embodiments, it will be evident that various modifications and changes may be made to these embodiments without departing from the broader spirit and scope of the various embodiments.

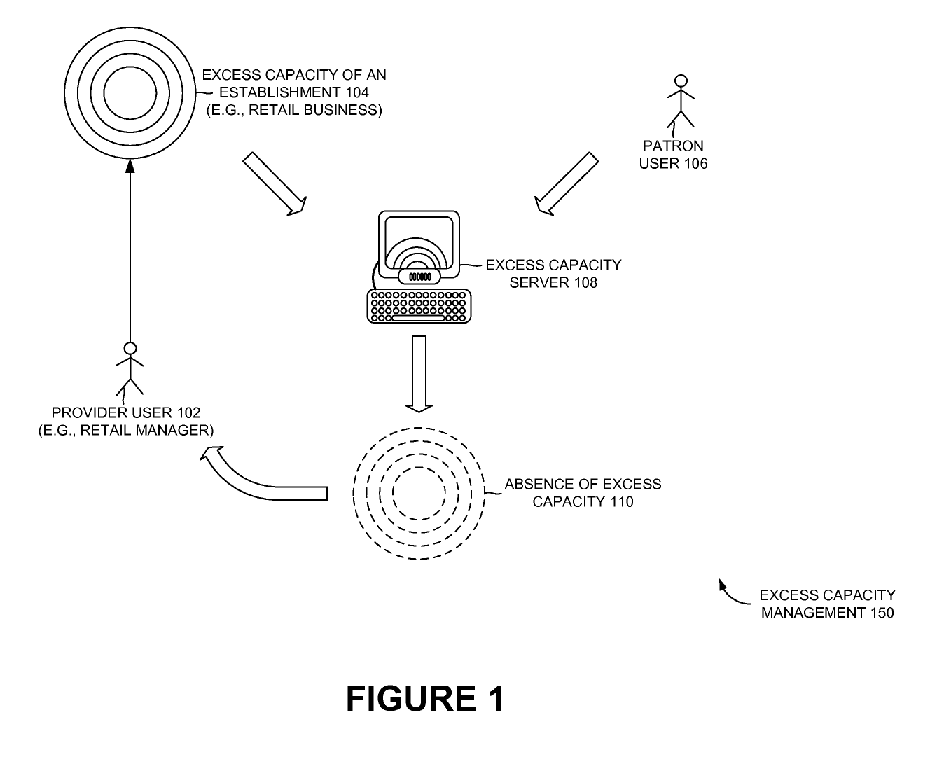

FIG. 1 is a schematic view illustrating excess capacity management of an establishment, according to one embodiment. Particularly, FIG. 1 illustrates a provider user 102 (e.g., retail manager), an excess capacity of an establishment 104 (e.g., retail business), a patron user 106, an excess capacity server 108, and an absence of excess capacity 110, according to one embodiment.

According to one embodiment, the provider user 102 of an establishment having an excess capacity may be associated with the excess capacity server 108. The provider user 102 (e.g., retail manager) may store the details regarding the excess capacity in the excess capacity sever 108. The establishment may be a restaurant, a bar, a diner, a spa, a cafeteria, a health resort, a retail service organization, etc. that may provide service to a consumer. The excess capacity of an establishment 104 (e.g., retail business) may be reduced and/or eliminated through the various embodiment disclosed herein. The excess capacity of an establishment 104 may include meals, beverages, eatables, perishable and consumable goods, dinner, etc. The excess capacity of an establishment 104 (e.g., retail business) may be assigned a pricing table provided by the provider user 102. The prices for an excess capacity may be assigned based on a meal plan, a day variable, a time variable, a location in the region of the establishment, etc.

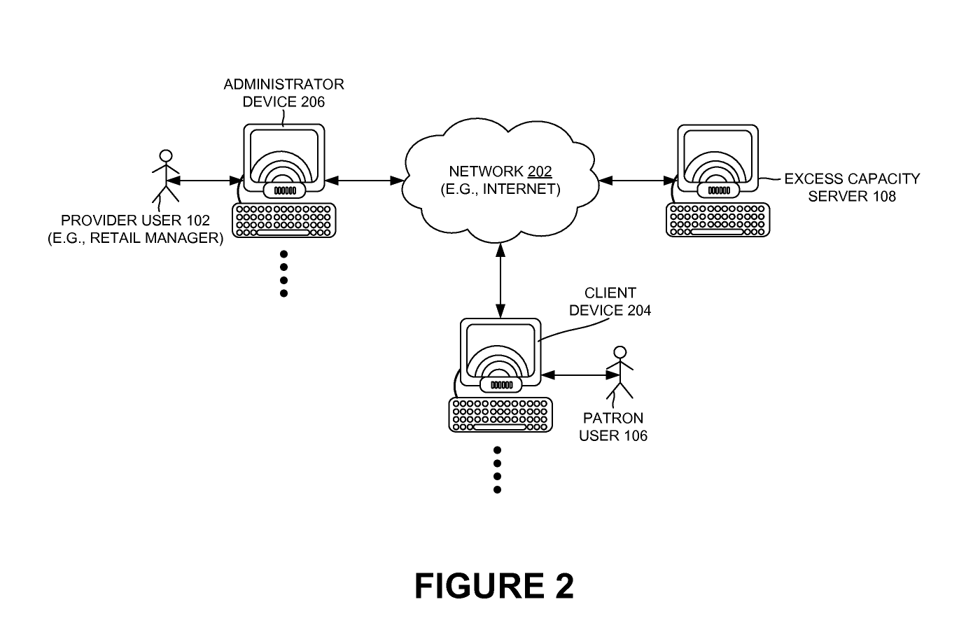

Further, the patron user 106 may utilize the excess capacity of the provider user 102 by communicating with the excess capacity server 108 through a network 202 (as illustrated in FIG. 2). The patron user 106 may be an individual patron user, a representative of a group of patrons, an agent for the patron user, a group patron user, etc. For example, the patron may be a customer of the retail establishment or a concierge representing a group of potential customers. The excess capacity server 108 may enable the provider user 102 to customize various settings related to managing excess capacity, and may provide an interface in which the patron user 106 can access the excess capacity server 108. If a patron user is determined as an agent of an actual patron user, a referral incentive may be paid to the agent when the reservation is confirmed.

FIG. 2 is a system view that illustrates communication between a patron user and a provider user of an establishment through a network, according to one embodiment. In particular, FIG. 2 illustrates a network 202, a client device 204, an administrator device 206, the provider user 102, the patron user 106, and the excess capacity server 108, according to one embodiment.

In one embodiment, the patron user 106 may communicate with the provider user 102 (e.g., retail manager) through the network 202 to obtain the services of the excess capacity associated with an establishment (e.g., a restaurant, a spa, a movie theater, a hair cut salon, any retail service organization, etc.). The network 202 (e.g., WAN, mobile, telecommunications, internet, intranet, WiFi and/or ZigBee network, etc.) may enable communication between the administrator device 206, the client device 204, and the excess capacity server 108. The administrator device 206 and the client device 204 may request a service function from the excess capacity server 108. The client device 204 may be associated with the patron user 106 and the administrator device 206 (e.g.., a computer, a Point of Sale system such as the Micros® or Aloha® point of sale terminal, etc.) may be associated with the provider user 102 (e.g., retail manager).

According to one embodiment, the provider user 102 may input the details of the excess capacity in the excess capacity server 108 through the administrator device 206. The details associated with the excess capacity of an establishment (e.g., a restaurant, bar, spa, etc.) may include meal option, day, time, geographical location, table size, special size offers, promotions, discounts, food combination, beverage pairings with or without meal combinations, periodical sales, special occasion sales, auction etc. The excess capacity may be assigned a pricing table based on a meal plan, time of a day, and a location in the region of the establishment.

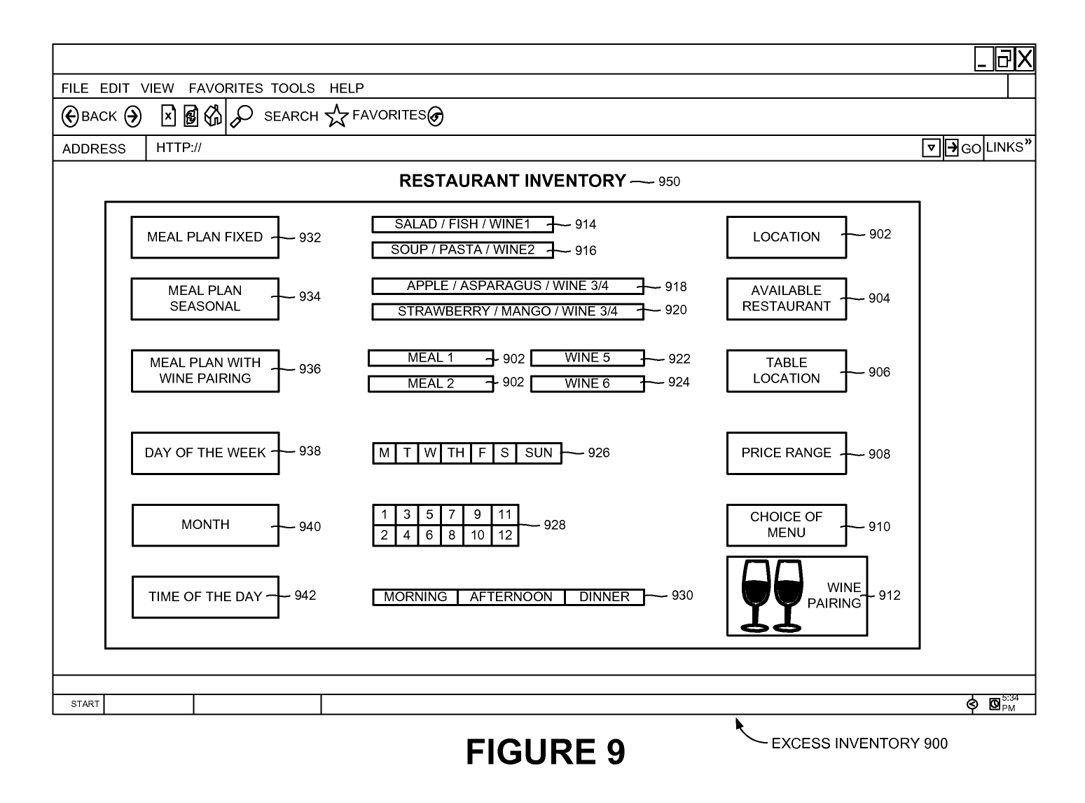

The aforementioned details of the excess capacity may be retried by the patron user 106 through an online website such as the FineDineDeal.com website. For example, a search criteria and a reservation may be made by selecting from a retail establishment inventory (e.g., a restaurant inventory) as illustrated in FIG. 9. The generated search result may include the list of establishments with excess capacity that matches with patron user's criteria. The criteria of the patron user 106 may include a date selection, a time selection, a meal plan selection, a location selection, a cuisine selection, etc.

While an example of a restaurant retail establishment will be described, it will be appreciated by those with skill in the art that the following analogy can apply to any form of retail establishment which services patrons including spas, movie theaters, nightclubs, bars, gyms, auditoriums, and/or civic meeting spaces. In a restaurant retail establishment example, the patron user 106 may select a restaurant with excess capacity that may provide wine paring, beverage pairing and/or a dessert. Further, the selection of an excess capacity may also be based on the party size of the patron user 106.

In another embodiment, the provider user 102 (e.g., retail manager, an establishment manager, etc.) may create a set of meal plans based on the modeling of the establishment and the seasonal availability and offer a set of meal plans as an option to the patron user 106. In an example embodiment, the provider user 102 may provide restaurant guide, chat/message board, a referral center to enable the patron user 106 to interact with the provider.

In yet another embodiment, the patron user 106 can make a reservation based on the availability of the excess capacity and confirm the reservation to the provider user 102 by making a financial payment.

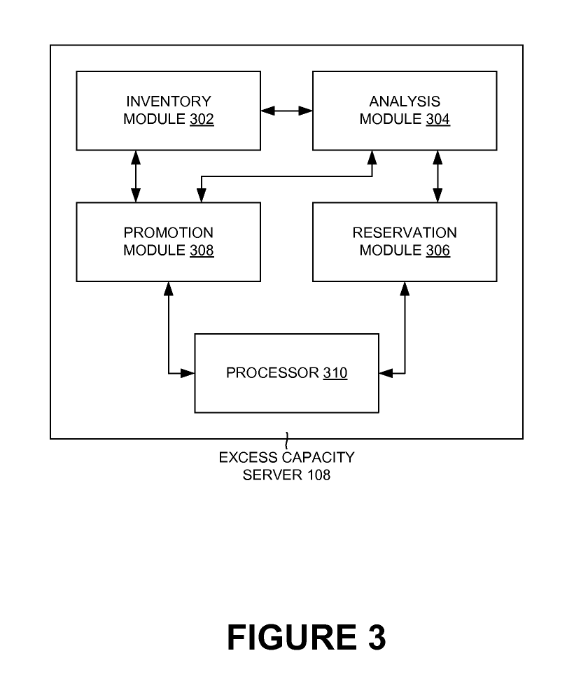

FIG. 3 is an exploded view of the excess capacity server, according to one embodiment. In particular, FIG. 3 illustrates an inventory module 302, an analysis module 304, a reservation module 306, a promotion module 308, and a processor 310, according to one embodiment.

In an example embodiment, the excess capacity server 108 may include the inventory module 302, the analysis module 304, the reservation module 306 the promotion module 308 and the processor 310. In another example embodiment, the inventory module 302, the analysis module 304, the reservation module 306, the promotion module 308 and the processor 310 may be communicatively couple to each other as illustrated in FIG. 3.

According to one embodiment, the inventory module 302 may associate the inputs of the provider users and store as an inventory (e.g., catalog, register, etc). The contents of the inventory module 302 may be provided in the search result when the patron user 106 searches for a restaurant, meal plan, etc in the example embodiment described in detail herein. Again, it is noted that the claims are not limited to the restaurant example disclosed herein and can be applied to any form of retail establishment in which there is excess capacity, according to one embodiment. The analysis module 304 may compile the availability of an excess capacity of the establishment based on the inputs of the provider users and provide the information to the patron user 106.

The analysis module 304 may inform the provider user 102 (e.g., retail manager) regarding the reservations made by the patron user 106. Once a reservation is made by the patron user 106, the analysis module 304 may recalculate the excess capacity. In addition, the analysis module 304 may block the excess capacity that are reserved by the patron user 106 and make the excess capacity available to the other patron users once the patron user 106 cancels the reservation. Further, the cancellation of the reservation may be informed to the provider user 102.

The reservation module 306 may verify the availability of the excess capacity of the establishment (e.g., seating and meal package of a restaurant, wine pairing, etc.) that is preferred by the patron user 106, and allocate the excess capacity. At the time of multiple selection orders for the excess capacity, the reservation module 306 may assign a priority number based on the selection criteria. If the first selection of reservation is unavailable because of allocation of excess capacity to a first priority patron user, then a subsequent selection of reservation may be allocated to the patron user. Also, when a reservation is cancelled the offer may be allocated to a next priority user. The patron user 106 may himself/herself cancel the reservation or the reservation may be cancelled due to an unacceptable financial payment. The reservation module 306 may accept the financial payment for a reservation and also authenticate the financial payment provided by the patron user 106. In addition the reservation module 306 may update a confirmation of the reservation and provide a notification of the confirmation to the patron user 106 and the establishment (e.g., a restaurant, bar, etc.) associated with the reservation.

The promotion module 308 may include the promotions offered by the provider user 102 of the excess capacity of an establishment 104. The establishment may provide sponsorship, discounts, and/or special offers to promote the sales of the excess capacity of an entity. The promotions may include a seasonal discount, a group discount, instant discount, an anniversary sale, a special sale, auction, gifts, and/or vouchers. The processor 310 may process the requests for an excess capacity based on search criteria of the patron user 106 and provide the processed results to the patron user 106. The criteria of a patron user may be a date selection, time selection, a location selection, a cuisine selection, etc.

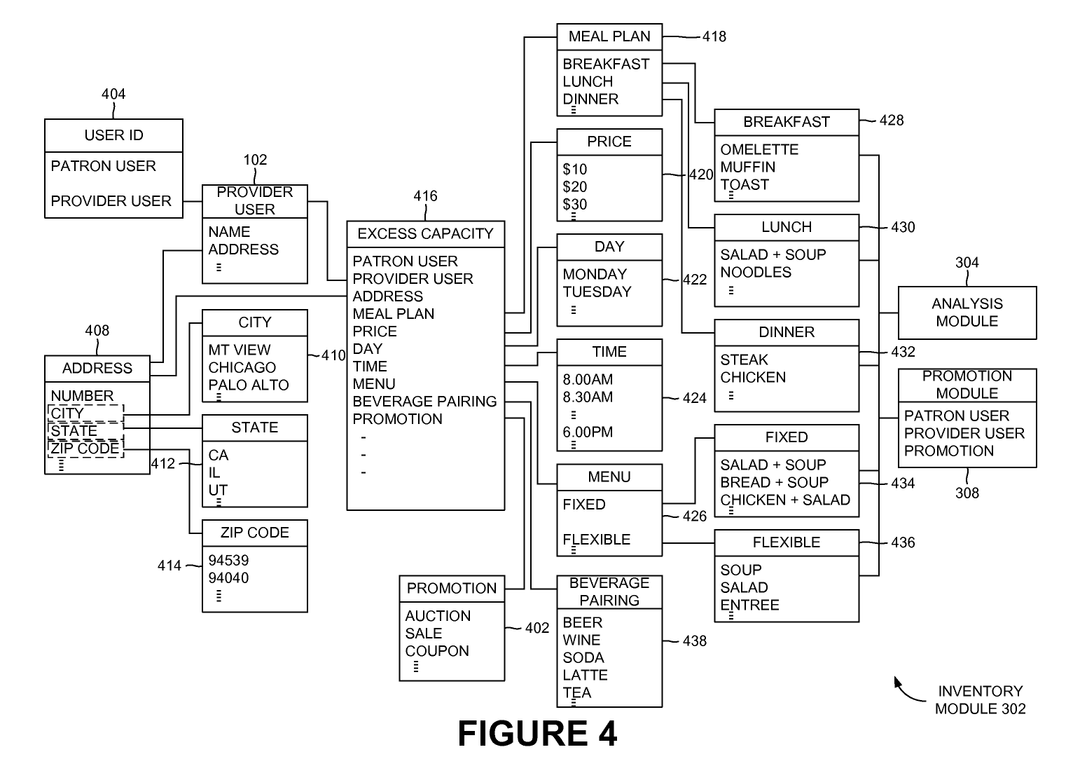

FIG. 4 is diagrammatic view illustrating generation of an inventory module by a provider user, according to one embodiment. In one embodiment, the provider user 102 (e.g., retail manager) may be enabled to input excess capacity to the inventory module 302. The input may include the details of excess capacity and the establishment of the provider user 102. For example, the input may include a meal option, food combination, a beverage pairing with meal or without meal combination, a sale during predetermined period of a year, seasonal sale and/or an auction. The details provided by the provider user 102 may be stored in the inventory module 302 as an inventory along with their name and address. The address may include name, city, state, and/or zip code of the provider user. The aforementioned details of the excess capacity that are stored in a list of excess capacity 416 may be provided to the patron user 106.

Based on the match between the selection criteria of the patron user 106 and the availability of the excess capacity of an establishment 104, the excess capacity may be allocated to the patron user 106. The matching between the selection criteria and the availability of an excess capacity of an establishment 104 (e.g., retail business) may be performed by the analysis module 304. The provided inventory may be categorized and listed separately to provide as an option to the patron user 106. The option may include a geographical location (e.g., state, city, area, etc.), the feature of an excess capacity, the promotions provided by the provider user 102, the type of cuisines, etc. The excess capacity 416 may include an address of the establishment, meal plan, price of an excess capacity, time and day on which the excess capacity is available, beverage pairing, promotion, etc. as illustrated in the FIG. 4.

In another embodiment, the meal plan 418 may include breakfast, lunch, dinner, etc. A list, menu 426 may include fixed menu or flexible menu. For example, a list of a fixed menu 434 may include salad and soup, bread and soup, chicken and salad, and so on. A flexible menu 436 may include soup, salad, entree, etc. The price of the meal plan may be set by the provider user 102 according to the meal shifts (e.g., breakfast, lunch, supper, dinner, etc). For example, the price of a meal plan available in the afternoon may be costlier than the price of same meal plan at different timings of the day. Also, the meal plan may be selected by the patron user 106 based on the pricings of the meal packages. Further, the price packages may also be set based upon a day of a weak, meal shift, and/or other time slots. The patron user may choose a meal plan based on the prices listed in a list 420.

A list of breakfast 428 of the meal plan 418 may include omelet, muffin, toast, and others that are available in the list of excess capacity 416. A list of lunch 430 may include salad and bread, noodles, pasta, etc that may be provided by the provider user 102. A list of dinner 432 of the meal plan 418 may include chicken, steak, sandwich, burger, etc. The meal plan 418 may also be paired with beverages. A list of beverage pairing 438 may include beer, wine, soda, latte, etc. According to one embodiment, a price of a beverage may be listed in a price list 420, but the actual brand of the selected beverage may be not provided to the patron user. For example, the price of wine may be provided in the price list 420 but, the type of wine served may not be provided to the patron user 106.

The options of the excess capacity 416 provided to the inventory module 302 may be analyzed by the analysis module 304 to allocate the excess capacity to the patron user 106. The excess capacity 416 may also provide an option of promotion, in which the promotion may be an offer provided by the provider user 102. For example, the list of promotion 402 may include some special sales, discounts, coupons, auction offers, gifts, bid, etc.

According to one embodiment, the establishment (e.g., restaurant, bar, etc) may be enabled to collect historical data and contemporaneous data and statistically calculate excess capacity of an establishment 104 (e.g., retail business), and generate data for the inventory module 302. This data may be updated regularly and synchronized with the updates of the provider user 102 and the reservation module 306.

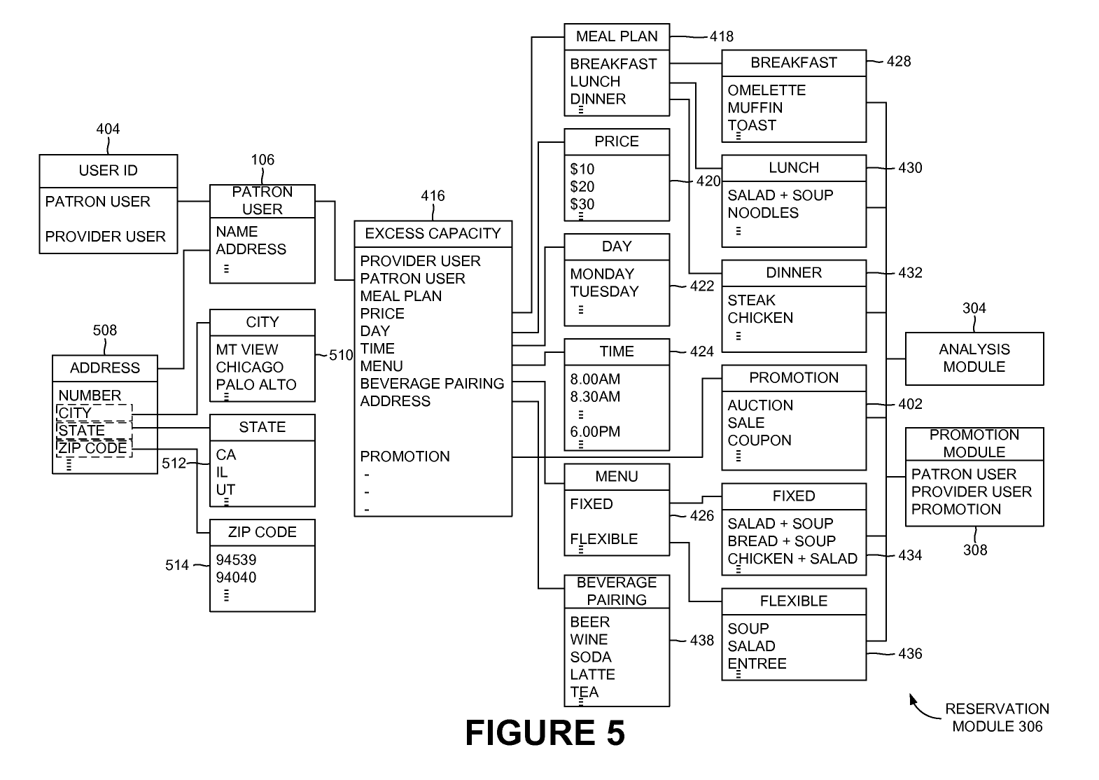

FIG. 5 illustrates reservation of an excess capacity of an establishment by a patron user, according to one embodiment. In particular, reservation of a meal by the patron user 106 is illustrated in FIG. 5. In one embodiment, the reservation module 306 may identify the requisites of the patron user 106 which are based on the time of day variable, the meal plan variable, the location in the region of the establishment, the price variable, and/or the promotion variable. The availability of the requisites of the patron user 106 may be verified against the excess capacity provided by the provider users. If the excess capacity is matched with the criteria of the patron user 106, the reservation can be made by making a financial payment to the provider user 102 (e.g., retail manager). When the provider user 102 will accept the financial payment for the reservation, the reservation module 306 may be updated with the confirmation of the reservation and further, the patron user 106 may be informed regarding the confirmation of the reservation.

In another embodiment, the reservation may be cancelled by the patron user 106 and a refund may be provided to the provider user 102 for the cancellation. The freed excess capacity may be allocated to another patron user.

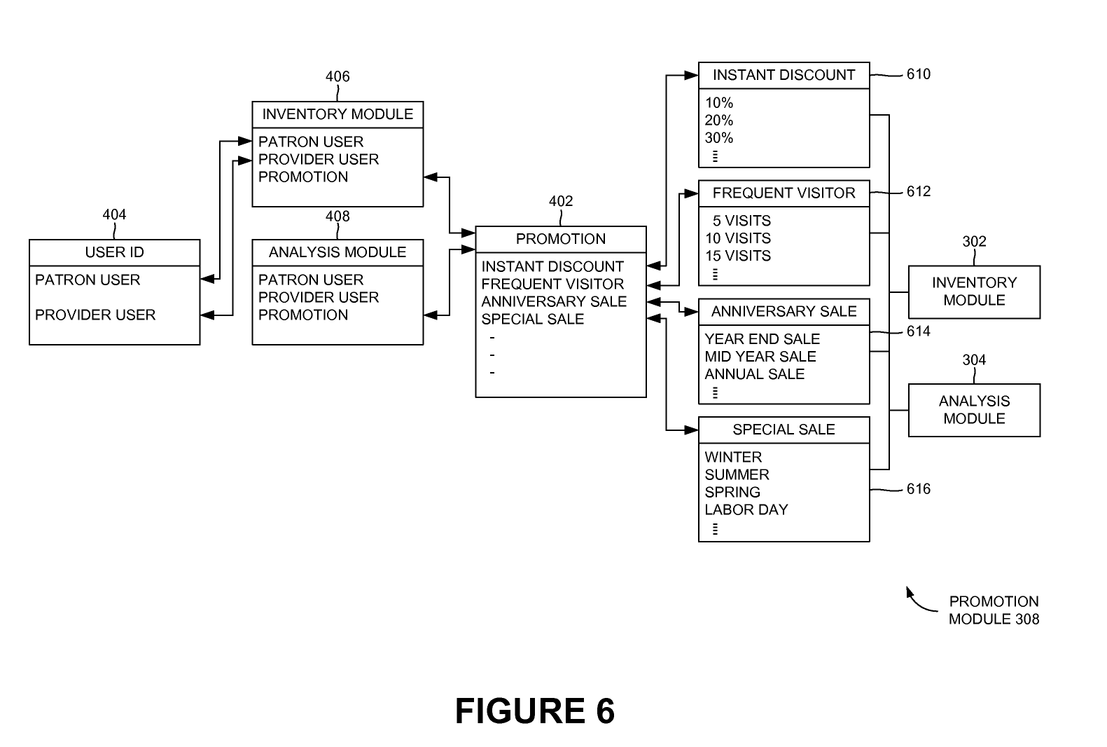

FIG. 6 is a flow diagram illustrating promotion module, according to one embodiment. According to one embodiment, a provider user 102 of an establishment (e.g., a diner, restaurant, etc.) may offer promotions on the excess capacity to reduce the excess capacity. For example, the promotion 402 offered by the provider user 102 of the establishment may include special sale, instant discount on online booking, offers to the frequent visitors, anniversary sale, auctions, etc.

In another embodiment, the patron user 106 may be allowed to participate in an online auction for one or more gift certificates. To enable a patron user to find an auction of interest, various search options may be provided. For example, the patron user 106 may be able to search auctions based on a restaurant, cuisine, city, etc. Further, the patron user 106 may also obtain additional information relating to the auction of the excess capacity through the promotion module 308.

In yet another embodiment, the promotion 402 may be offered to frequent registered visitors. For examples, an establishment may register a user who may be visiting frequently and depending upon the number of visits, the user may be offered various types of promotions by the establishment. In one or more embodiments, the promotion 402 may include instant discount 610, a frequent user 612, an anniversary sale 614, a special sale 616, etc.

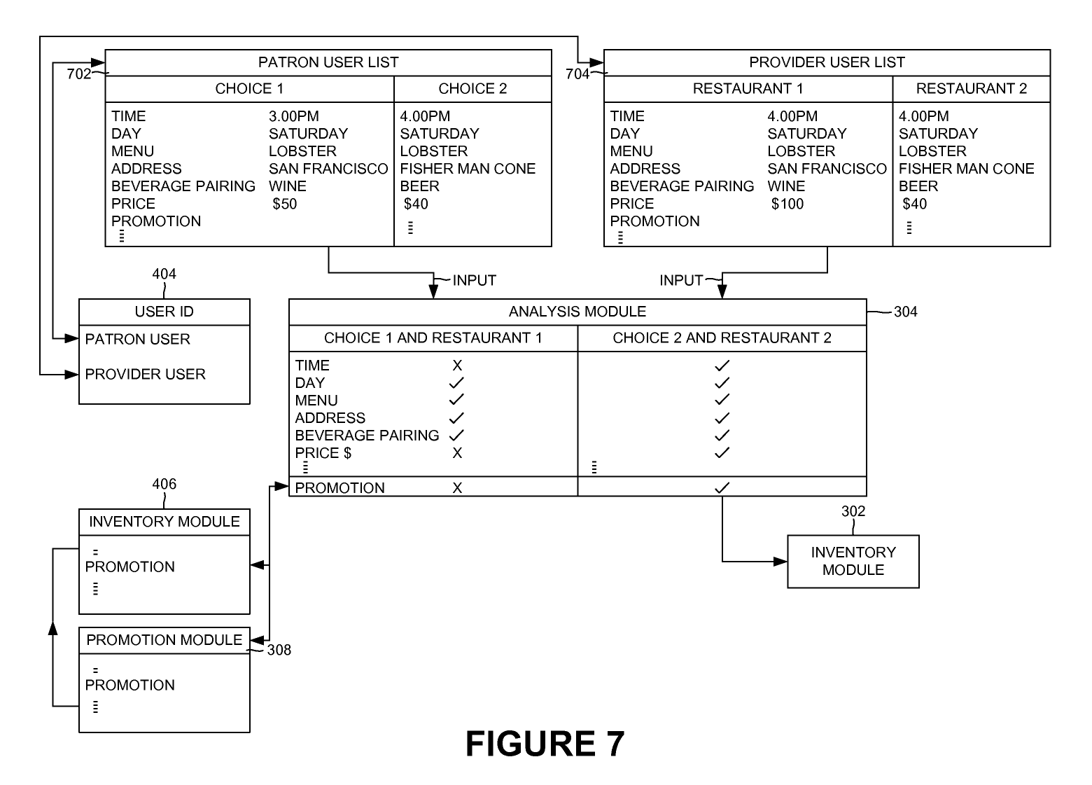

FIG. 7 is diagrammatic view illustrating analysis of a patron user request against availability of provider user, according to one embodiment. In an embodiment, the choices made by the patron user 106 may be analyzed against the options provided by the provider user 102. The analysis may be made through the analysis module 304. The analysis module 304 may analyze a patron user list 702 against the provider user list. Based on the result of the analysis the reservation can be made by the reservation module 306 to manage the excess capacity of an establishment.

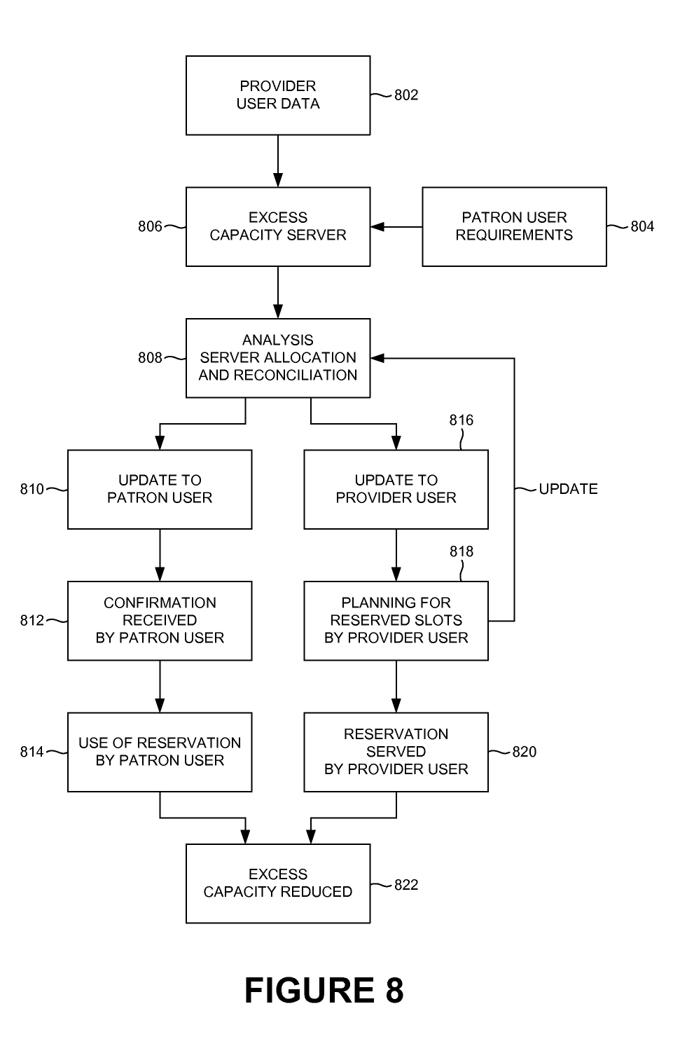

FIG. 8 is a flow chart illustrating excess capacity management of an establishment, according to one embodiment. In operation 802, a provider user (e.g., the provider user 102) data is provided to the excess capacity server 108 by the provider user 102. For example, the provider user 102 data may include a meal plan variable, a day and time variable, a price variable, special occasion sales and auction, etc. In operation 804, the patron user 106 may request the excess capacity server 108, for the details of an establishment availing excess capacity. For example, the patron user 106 may request for a restaurant with a particular cuisine, meal package, location, etc.

In operation 806, the excess capacity server 108 may receive the inputs from the provider user 102 (e.g., retail manager) and the patron user 106. In operation 808, the requisites of the patron user 106 may be statistically analyzed against the provider user data to allocate the excess capacity and the reservations may be reconciled based on the patron user's criteria. In operation 810, the analysis made in the operation 808 may be informed to the patron user 106. In operation 812, a confirmation regarding the acceptance of the reservation of an excess capacity may be received by the patron user 106.

In operation 814, the reservation allocated in operation 812 may be used by the patron user 106. In operation 816, the provider user 102 of an establishment may be updated regarding the requisites submitted by the patron user 106. In operation 818, the reserved slots may be planned by the provider user 102 after receiving the financial payment from the patron user 106. In operation 820, the reserved slots may be served to the provider user 102. In operation 822, the excess capacity of an establishment 104 is reduced through the operations 802-820.

FIG. 9 is a user interface view illustrating inventory of a restaurant having excess capacity, according to one embodiment. In one or more embodiments, the patron user may be provided various options to reserve a restaurant. The restaurant may be selected on the basis of location, cuisine, date, time, party size, etc. Further, the restaurants may also be chosen on the basis of meal plans, wine pairing, table location etc as illustrated in FIG. 9.

In an example embodiment, a restaurant inventory 950 may provide users options to select from the available excess capacity of a restaurant. The inventory options may include a fixed meal plan 932 which may include salad, fish, wine 1 and soup, pasta, wine 2 as options of fixed meal (e.g., 914 and 916 as illustrated in FIG. 9). The restaurant inventory 950 may also include a meal plan seasonal 934 which may provide the meal options with seasonal fruits/vegetables and a meal plan with wine pairing 936. The options day of the week 938, month 940 and time of the day 942 may allow a user to select a period and timings to dine in a restaurant. The user may select a day or a month available in the lists 926 and 928.

In addition, the restaurant inventory 950 may also provide a location 902 of an available restaurant 904 and also a table location 906 in the available restaurant. The inventory of the restaurant may also provide an option price range 908, from which the meal of a required price range may be chosen by the patron user 106.

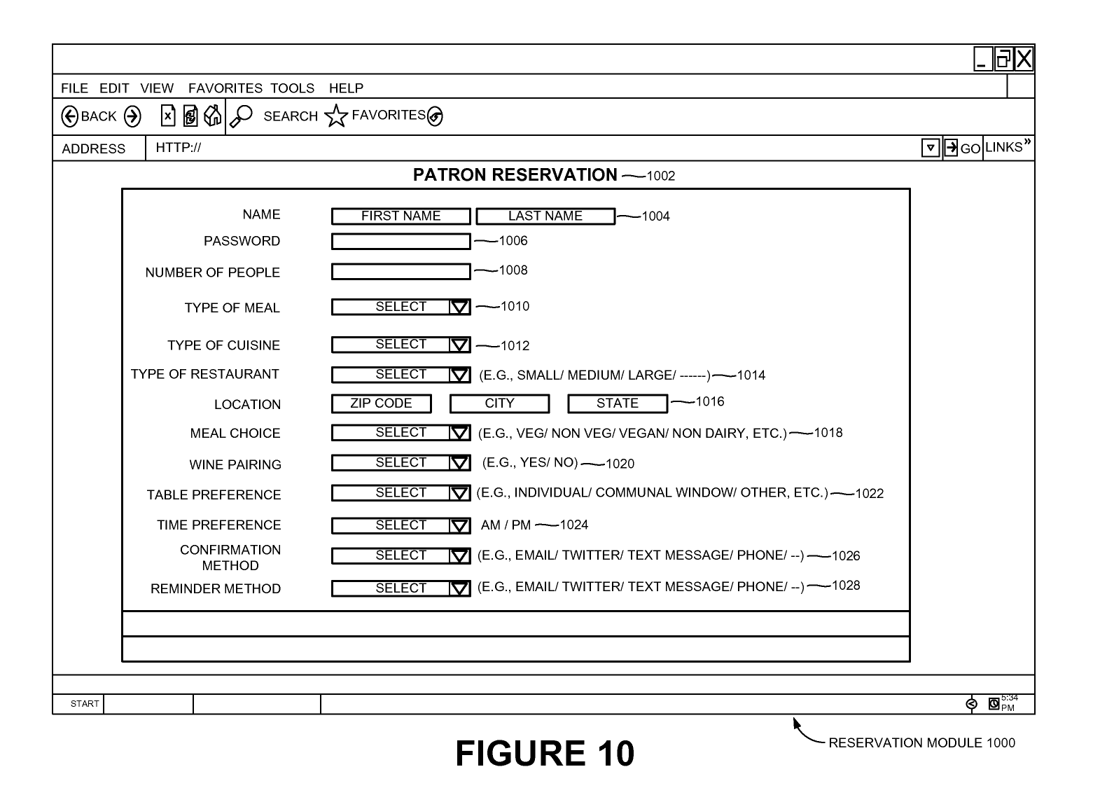

FIG. 10 is a graphical user interface view illustrating a patron user's reservation, according to one embodiment. In an example embodiment, the graphical user interface view of FIG. 10 may enable the patron user 106 to make a reservation by filling a patron reservation 1002 chart. The patron reservation 1002 chart may include name option (e.g., may include first name and last name), password and number of people option. The patron user 106 may make a reservation by selecting a type of restaurant, meal, cuisine, wine pairing, from the dropdown list available against each of the options (e.g., 1010, 1012, 1014, and 1020). Also, the patron reservation 1002 may provide time preference, table preference (e.g., individual, communal, window other, etc. 1022). The patron user 106 may select an option to choose the mode of receiving confirmation of the reservation (e.g., 1026). The confirmation of the reservation from the provider user 102 may be received through phone, e-mail, SMS text message, etc. Also, the user may select from the option 1028 the mode in which the reservation details may be reminded. For example, the user may be reminded of the reservation before a day, or few hours before the timings of reservation through phone call, text message, etc.

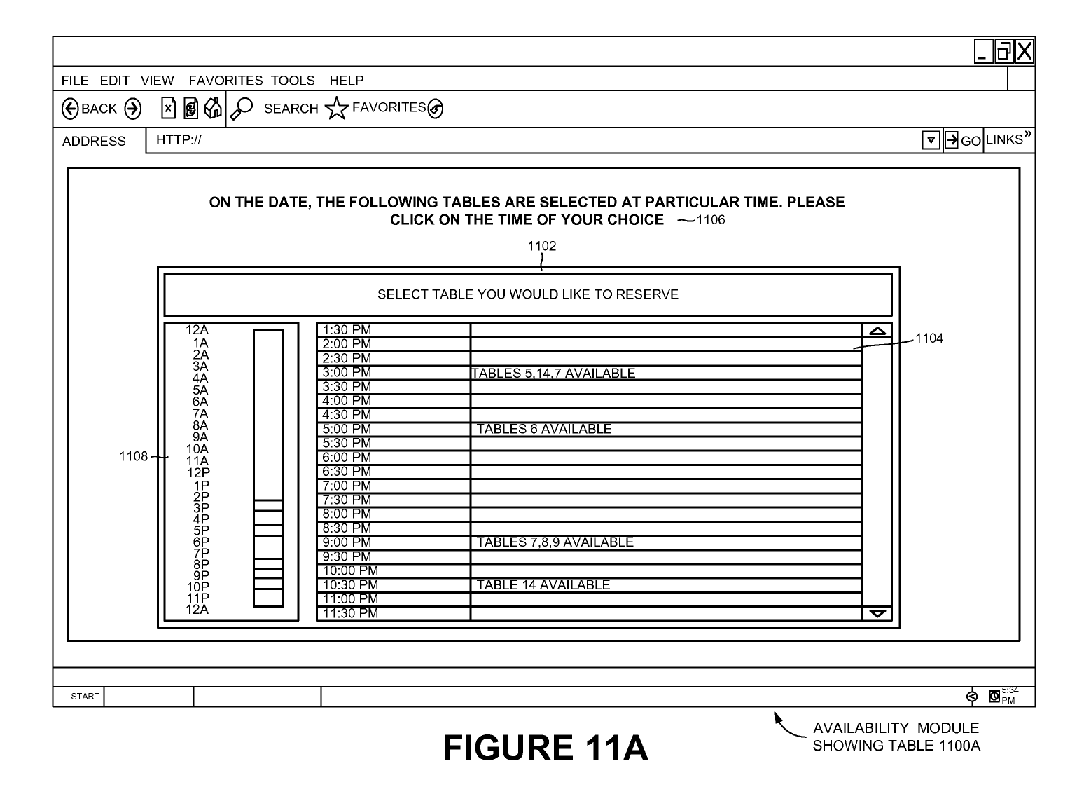

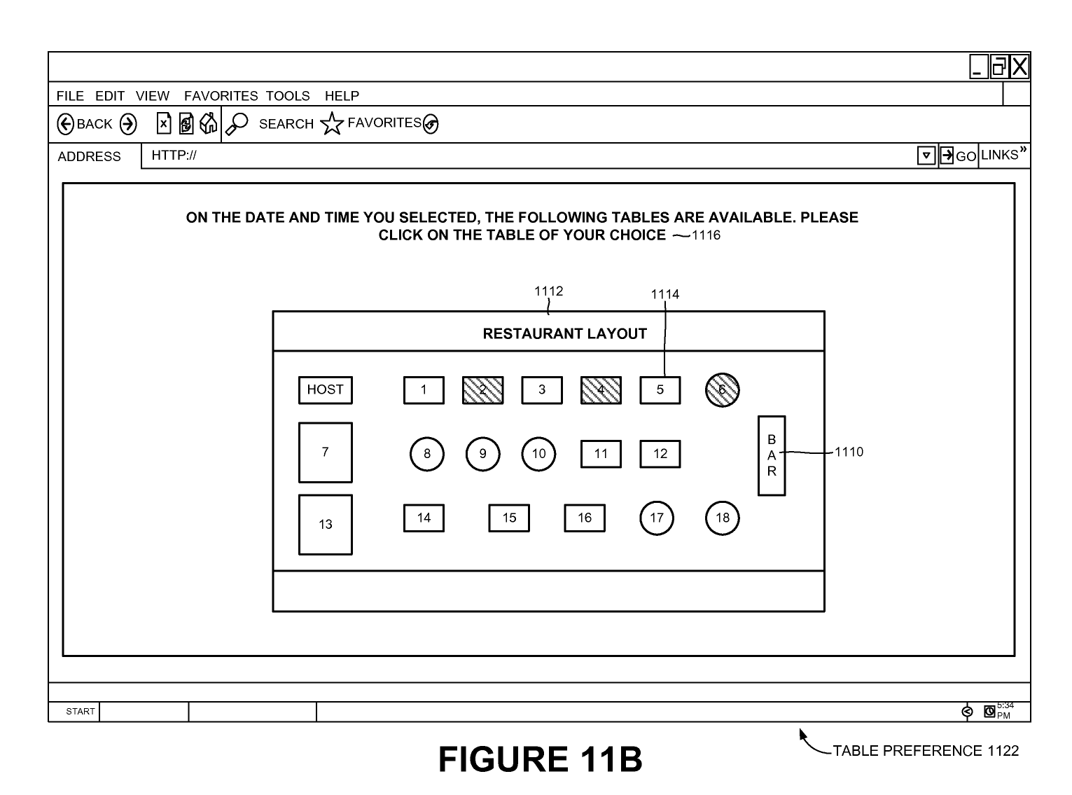

FIG. 11A is a user interface view illustrating the available tables at a particular time in a restaurant, according to one embodiment. In one or more embodiments, the available tables of a restaurant may be reserved on a particular time. The tables of restaurant that are available on a particular time may be listed in the table 1104 as illustrated in FIG. 11A.

FIG. 11B is a user interface view illustrating the layout of table arrangement in a restaurant, according to one embodiment. In one embodiment, the user may make a reservation of table based on the location of a table presented in the restaurant layout 1112 as illustrated in FIG. 11B. For example, the user may select any unreserved table based on the size of the table and/or shape of the table (e.g., round table, square table). Even the user may reserve the table on a window side, bar side, etc through the restaurant layout.

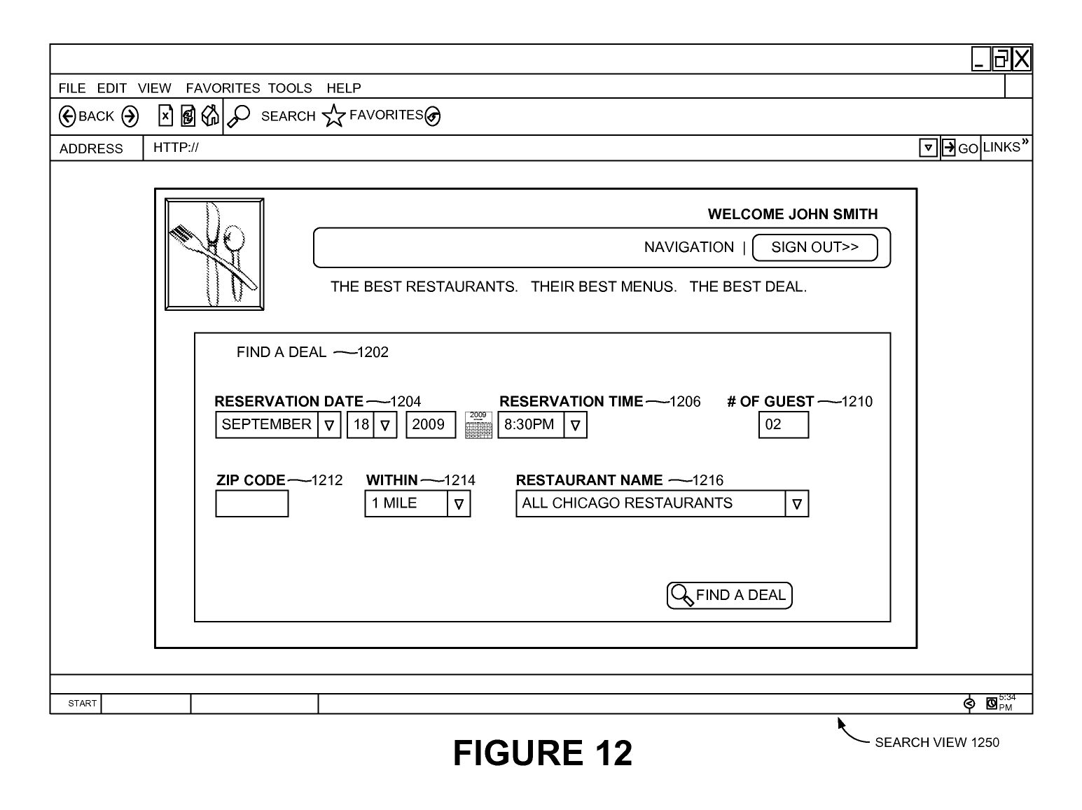

FIG. 12 is a graphical user interface illustrating a search view, according to one embodiment.

In one embodiment, a search view 1250 may facilitate a user (e.g., John smith) to find a deal for reservation. The deal may be a combination of selections which may include reservation date 1204, a reservation time 1206, number of guest 1210, a restaurant name 1216. Also, a restaurant may be selected based on the availability of a restaurant within a specified distance (e.g., within one mile, within five miles, etc) by selecting from an option (e.g., within 1214 as illustrated in FIG. 12).

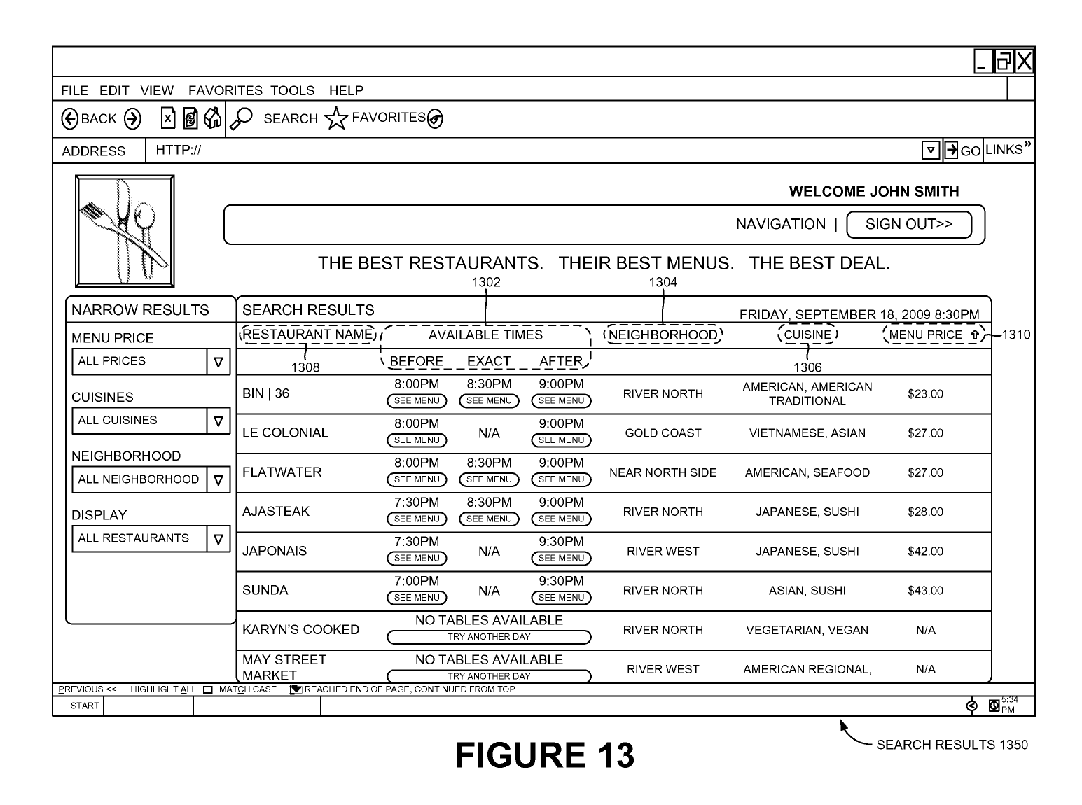

FIG. 13 is a graphical user interface view illustrating a search result, according to one embodiment.

In one or more embodiment, based on a search performed by the user (e.g., as illustrated in FIG. 12) a search result 1350 may be generated. The search result 1350 may include a list of restaurant name 1308 generated based on the criteria (e.g., within one mile, restaurants in Palo Alto, etc) of the user. The search result 1350 may also include available time 1302 (e.g., before, after, and/or an exact time), a neighborhood 1304, cuisine available in a restaurant 1306, and menu price 1310. Also, an option may be provided to the user to see the menu of the restaurant at a particular available time (e.g., before, after, exact).

For example, the search result may include a BIN/36 restaurant in the neighborhood of River North. The restaurant BIN/36 may provide American cuisine and/or American traditional cuisine for which the menu price may be $23.00. The available time 1302 of the restaurant for providing the service to the user may be before 8.00 PM, after 9.00 PM, and/or exactly at 8.30 PM.

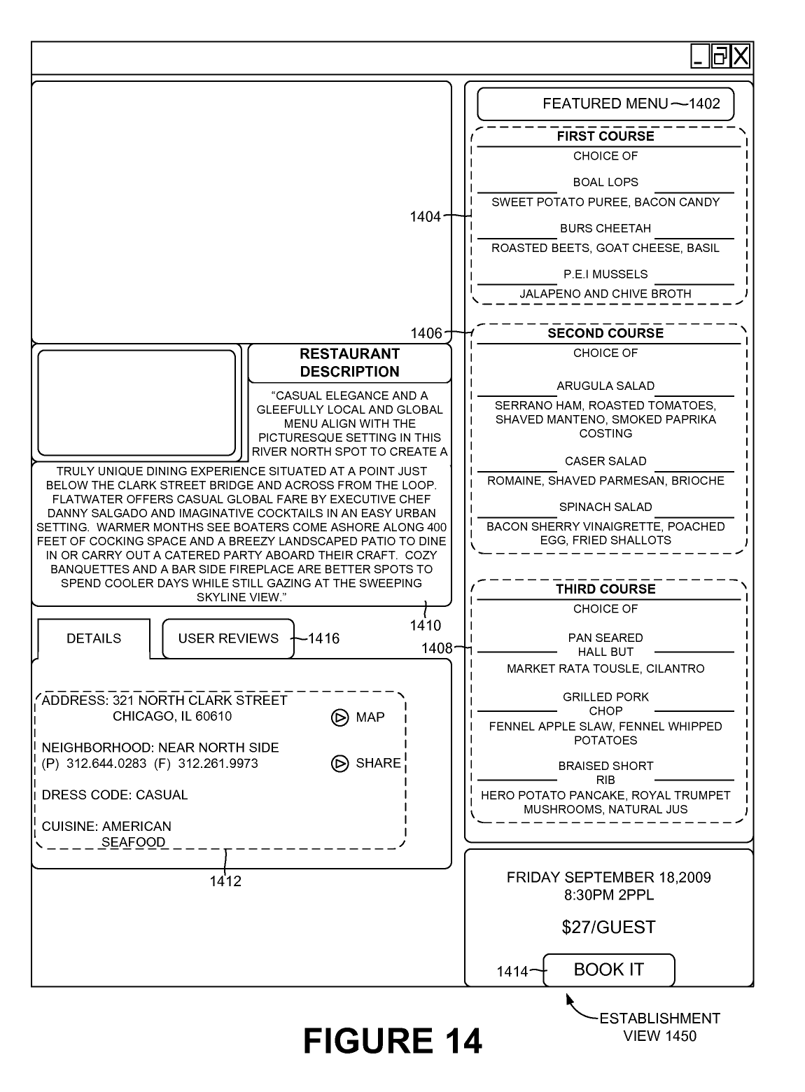

FIG. 14 is a graphical user interface view illustrating an establishment page, according to one embodiment.

In one embodiment, an establishment page 1150 illustrated in FIG. 14 may include a restaurant description 1410 that may provide the description of the establishment. The establishment page 1150 may also include featured menu 1402 list of the establishment which includes different courses (e.g., first course 1404, second course 1406, and third course 1408) of the menu. The courses may have various meal options and the user may choose from the list and book the reservation by selecting the button book it 1414 as illustrated in the FIG. 14. The establishment page may also provide details of the user reviews (e.g., user reviews 1416) provided by the other users who may have visited the establishment. The details and remarks of the user review may be included in a section, detail 1412.

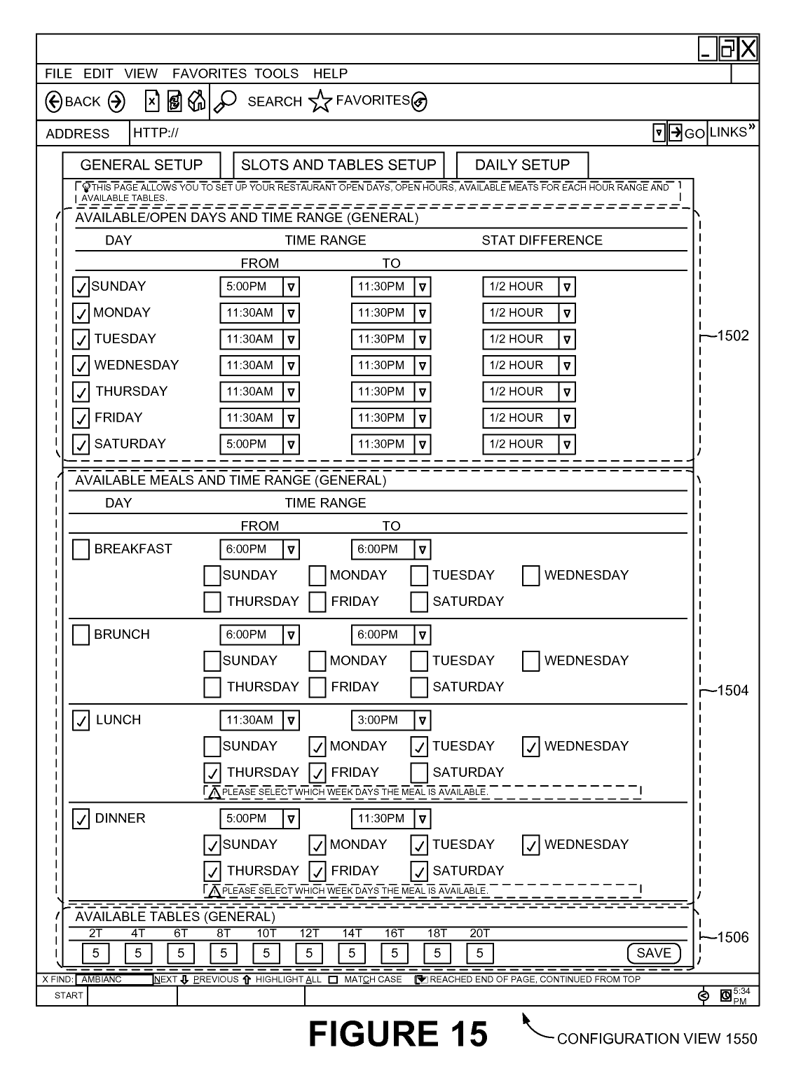

FIG. 15 is graphical user interface view illustrating a configuration view, according to one embodiment.

In one embodiment, an establishment manager (e.g., the provider user 102) may set up restaurant's available/open days and time range in table 1502 and available meals and time range in table 1504. The available tables in the restaurant may be configured in the table available table (general) 1506. The table available/open days and time range 1502 may allow setting of the available days of the restaurant and the time range on which the restaurant may be available to provide service to users (e.g., the patron user 106). Further, the table available meals and time range 1504 may allow setting of the available meals (e.g., break fast, brunch, lunch, etc.) in the restaurant at a particular time range and day. The table available tables 1506 may allow setting up of the available tables (e.g., unreserved tables) of the restaurant.

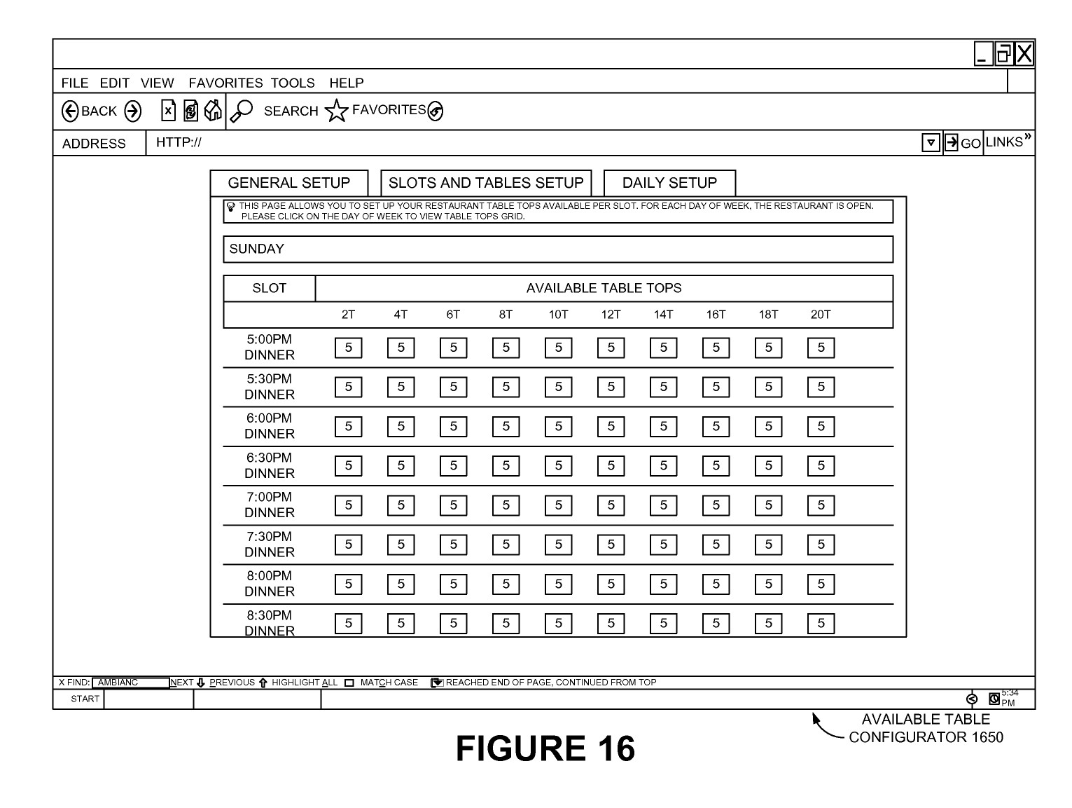

FIG. 16 is a graphical user interface view illustrating configuration of available tables, according to one embodiment. Various table sizes are illustrated in the figure denoted with a ‘T’. These table sizes are configurable by the provider user 102, according to one embodiment during the set up of the retail establishment in the excess capacity system, according to one embodiment. In addition, a patron user 106 may select and reserve a particular table as shown in FIG. 16, according to one embodiment. For example, according to one embodiment, available table configurator 1650 may allow the manager of an establishment (e.g., the provider user 102) to set up the tables per slot available on each day of a week when the restaurant is open.

Although the present embodiments have been described with reference to specific example embodiments, it will be evident that various modifications and/or changes may be made to these embodiments without departing from the broader spirit and/or scope of the various embodiments. For example, a combination of software and/or hardware may be used to enable the viral growth extension through recommendation optimization in online communities disclosed herein to further optimize function.

It will be appreciated that the various operations, processes, and methods disclosed herein may be embodied in a machine-readable medium and/or a machine accessible medium compatible with a data processing system (e.g., a computer system), and may be performed in any order.

The structures and/or modules in the figures are shown as distinct and communicating with only a few specific structures and not others. The structures may be merged with each other, may perform overlapping functions, and may communicate with other structures not shown to be connected in the Figures. Accordingly, the specification and drawings are to be regarded in an illustrative rather than a restrictive sense.

What is claimed is:

1. A computer implemented method, comprising:
creating a search result based on a criteria of a patron user using a processor,
wherein the search result includes an excess capacity across a plurality of establishments matching the criteria;
identifying an establishment when a selection of the patron user is processed responsive to the search result;
confirming a reservation of the patron user at the establishment with a payment authority and the establishment; and
adjusting the excess capacity based on the reservation.

2. The computer implemented method of claim 1, further comprising:
determining that a region of the establishment is the excess capacity based on an input of a provider user;
assigning to the excess capacity, a pricing table of the provider user, wherein the pricing table is a function of at least one of a time of day variable, a meal plan variable, and a location in the region of the establishment, and
wherein the criteria of the patron user is at least one of a date selection, a time selection, a meal plan selection, a location selection, a cuisine selection, and a category selection.

3. The computer implemented method of claim 2 wherein the determination of the excess capacity is algorithmically formed through a statistical analysis of a historical data and a contemporaneous reservation data.

4. The computer implemented method of claim 2:
assigning to a graphical representation of the establishment, specific locations in the establishment corresponding to regions of the excess capacity; and
permitting the patron user to select any of the specific locations when creating the reservation.

5. The computer implemented method of claim 2, further comprising:
identifying a selected meal plan with the reservation at the establishment;
matching the selected meal plan with a pairing table;
automatically recommending a set of pairings in the pairing table based on the match between the selected meal plan and the pairing table, wherein the set of pairing is at least one of a wine pairing, an appetizer pairing, a dessert pairing, a beverage pairing.

6. The computer implemented method of claim 2, further comprising:
automatically presenting to the provider user a set of meal plan variables based on a modeling of the excess capacity and a season of availability;
creating a set of meal plans offered by the establishment based on meal plan configurations created by the provider user using the meal plan variables; and
offering the set of meal plans as options of the establishment in the search result.

7. The computer implemented method of claim 2, wherein the establishment is at least one of a restaurant, a bar, a diner, a spa, and a retail services organization.

8. The computer implemented method according to claim 2, further comprising:
determining that the patron user is a representative of a group of patrons; and
applying a discount rate to each of the values of the pricing table to provide a discount to the patron user when the patron user is the representative of the group of patrons.

9. The computer implemented method of claim 2, further comprising:
determining that the patron user is an agent of an actual patron;
identifying an entity associated with the agent; and
providing a referral incentive to the agent when the reservation is confirmed.

10. A system comprising:
an excess capacity server having a processor to determine that a region of an establishment is an excess capacity, to present the region to a provider user, and to assign to the excess capacity, a pricing table of the provider user,
wherein the pricing table is a function of at least one of a time of day variable, a meal plan variable, and a location in the region of the establishment;
a network; and
a client device communicatively coupled with the excess capacity server through the network to create a search result based on a criteria of a patron user, wherein the search result includes the excess capacity across a plurality of establishments matching the criteria, to identify the establishment when a selection of the patron user is processed responsive to the search result, to confirm a reservation of the patron user at the establishment with a payment authority and the establishment, and to adjust the excess capacity based on the reservation.

11. The system of claim 10, wherein the criteria is at least one of a date selection, a time selection, a meal plan selection, a location selection, a cuisine selection, and a category selection.

12. The system of claim 10, wherein the determination of the excess capacity is algorithmically formed through a statistical analysis of a historical data and a contemporaneous reservation data.

13. The system of claim 10:
wherein a graphical representation of the establishment is assigned specific locations in the establishment corresponding to regions of the excess capacity, and
wherein the patron user is permitted to select any of the specific locations when creating the reservation.

14. The system of claim 10:
wherein a selected meal plan is identified with the reservation at the establishment,
wherein the selected meal plan is matched with a pairing table, and
wherein a set of pairings in the pairing table is automatically recommended based on the match between the selected meal plan and the pairing table, wherein the set of pairing is at least one of a wine pairing, an appetizer pairing, a dessert pairing, a beverage pairing.

15. The system of claim 10:
wherein a set of meal plan variables is automatically presented to the provider user based on a modeling of the excess capacity and a season of availability,
wherein a set of meal plans offered by the establishment are created based on meal plan configurations created by the provider user using the meal plan variables, and
wherein the set of meal plans are offered as options of the establishment in the search result.

16. The system of claim 10, wherein the establishment is at least one of a restaurant, a bar, a diner, a spa, and a retail services organization.

17. The system to claim 10:
wherein the patron user is a representative of a group of patrons, and
wherein a discount rate is applied to each of the values of the pricing table to provide a discount to the patron user when the patron user is the representative of the group of patrons.

18. The system of claim 10:
wherein the patron user is an agent of an actual patron,
wherein an entity associated with the agent is identified, and
wherein a referral incentive is provided to the agent when the reservation is confirmed.

19. An excess capacity server comprising:
an inventory module:
to associate an input of a provider user with at least one of a time of day variable, a meal plan variable, and a location in a region of an establishment, a price variable, a sale variable, and an auction status selection using a processor;
an analysis module:
to aggregate input from a plurality of provider users,
to compile an availability of an excess capacity of the establishment based on the aggregate input,
to recalculate the excess capacity after a reservation is made by a patron user,
to provide information to the provider user of the reservation of the patron user,
to block other reservations for the excess capacity that has been reserved,
to make the excess capacity available once a patron user cancels the reservation, and
to notify the provider user of a cancelation;
a reservation module:
to identify a status of the patron user,
to select the excess capacity of the establishment based of at least one of the time of day variable, the meal plan variable, and the location in the region of the establishment, the price variable, the sale variable, and the auction status selection,
to verify the selection based on at least one of the time of day variable, the meal plan variable, and the location in the region of the establishment, the price variable, the sale variable, and the auction status selection,
to verify the availability of the excess capacity of the establishment,
to authenticate a financial payment provided by the patron user,
to accept the financial payment for the reservation,
to update a confirmation of the reservation, and
to provide notification of the confirmation to the patron user and the provider user; and
a promotion module:
to offer a special sale, a group discount, and a seasonal discount provided by the provider user, and
to notify the patron user of the special sale, the group discount and the seasonal discount.

20. The excess capacity server of claim 19, wherein the meal plan variable is paired with a pairing variable, wherein the pairing variable is at least be one of an alcoholic beverage, a smoothie, a cheese selection, a dessert selection, an appetizer, and a drink selection.

21. The excess capacity server of claim 20, wherein the meal plan variable is fixed to a particular multi-course menu option.

22. The excess capacity server of claim 19, wherein the patron user is at least one of an individual patron user, a group patron user, and an agent for the patron user.

23. The excess capacity server of claim 22, wherein an incentive is processed for the agent of the patron user based on a criteria provided by the provider user to reduce the excess inventory of the establishment.

24. The excess capacity server of claim 22, wherein a refund is provided to the patron user based on the cancelation of the reservation based on a match with a criteria provided by the provider user.

25. The excess capacity server of claim 22, wherein the excess capacity server
to receive an offer when input is the auction status selection from the patron user,
wherein the offer comprises at least one of the criteria provided by the provider user,
to determine if the offer is acceptable to the provider user,
to reserve the excess capacity of the establishment if the offer is acceptable to the provider user,
to debit to the patron user when the offer is acceptable to the provider user, and
to credit to the patron user when the offer is unacceptable to the provider user,
wherein the patron user change of reservation is updated, an other reservation is verified with the provider user, and the difference in financial value for excess capacity of the establishment is reconciled,
wherein a reservation server
to assign a chronological number for a multiple selection orders,
to allocate a priority number based on a selection criteria, in the event of unavailability of a first multiple selection reservation, then a subsequent multiple selection reservation is allocated as a next choice to the patron user,
wherein upon cancelation the reservation, the offer is extended to a next patron user,
wherein the selection further comprises a matching of at least one of the criteria comprising a price that the patron user is willing to pay, a date, a time, and an availability of the excess capacity of the establishment, and
wherein the patron user is allowed to select another price if a first selection is rejected by the excess capacity server based on the criteria entered by the provider user.
